(19) United States
(12) Patent Application Publication
(10) Pub. No.: US 2002/0079191 A1
(43) Pub. Date: Jun. 27, 2002

(54) Method and device for the gathering of flat articles

(75) Inventor: Beat Studer, Durnten (CH)

Correspondence Address: RANKIN, HILL, PORTER & CLARK, LLP, 700 HUNTINGTON BUILDING, 925 EUCLID AVENUE, CLEVELAND, OH, 44115-1405, US

(73) Assignee: Ferag AG, Hinwil (CH)

(21) Appl. No.: 10/024,868

(22) Filed: Dec. 19, 2001

(30) Foreign Application Priority Data
Dec. 27, 2000 (CH) 2525/00

(51) Int. Cl. B42B 2/00

(52) U.S. Cl. 198/418

(57) ABSTRACT

Flat articles (5) are gathered into stacks (9) by conveying stacks in production successively along a gathering route (1) past feed stations and by adding one article to each stack in every feed station. The stacks (9) in production are conveyed on stack supports (2) with supporting surfaces (7). The supply direction of the articles comprises a component parallel to the stack conveyance direction and the supporting surfaces (7) are advantageously arranged not in parallel to the gathering route (1). The articles (5), each respectively gripped by a holding element (4) on one of their edges (5.1), are conveyed along a supply route (3) to the feed station. The supply route (3) traverses the gathering route (1) at the feed station. The articles (5) are inserted between successive stacks (9) or stack supports (2) respectively e.g. from above with their leading edges (5.1) held gripped. The gripped edge is released from being held by deactivation of the holding element (4), when it has reached the lower zone of the stack supports (2). The released article is then positioned on the upstream or downstream stack (9) or stack support (2) by the force of gravity and/or by its own inertia, and the holding element (4) is conveyed onwards in downward direction. A gathering operation of this kind is e.g. suitable for establishing dispatch units made up of different printed products. It allows very compact devices, which allow, with reasonable conveying speeds, gathering with high performance capacities. Furthermore, gathering of articles with very different formats is possible without any problems.

The invention is situated in the field of conveying and further processing of flat articles, in particular of printed products, and it concerns a method and a device for gathering flat articles, in particular for collating printed products.

In the printing field, a method for gathering or collating comprises forming stacks each comprising a plurality of printed products, wherein the printed products contained in each stack in general differ from one another and wherein usually all gathered stacks essentially contain the same printed products in substantially the same sequence. In dispatch station technique, for example, a multitude of finished printed products are gathered respectively into dispatch units which are then e.g. welded into a foil. Also in dispatch station technique, different supplements are gathered and then inserted as an enclosure into a main product, for example, into a newspaper. Both the mentioned finished printed products as well as the supplements may have very different formats and different thicknesses. In addition, it is becoming more and more usual also to process other flat articles, such as, for example, CDs or sample packages of the most diverse kind together with the printed products. In the field of book printing, for each book to be bound a plurality of signatures is gathered, each signature comprising a plurality of the book's pages and all signatures usually having the same format. It goes without saying, that in the same manner also “stacks”, which only comprise a single flat article, can be produced.

In accordance with prior art, printed products are gathered or collated by conveying stacks being produced behind each other along a collating route past a plurality of feed stations and by adding one printed product to each stack at every feed station. The stacks are conveyed along the collating route parallel to their flat expanse and lying in a horizontal or inclined position on a stack support, which is conveyed along with the stack or else is stationary and extending in the conveying direction. The printed products to be added to the stacks being conveyed past the respective feed station are in most cases supplied and deposited on the stack in a direction perpendicular to the stack conveying direction. It is known also to convey the stacks not parallel to the flat expanse of the printed products but each one lying on an inclined stack support which extends transverse to the direction of stack conveyance, and being supported in downward direction, the stack supports being conveyed along together with the stacks in production. To these stacks, the printed products to be added are usually supplied in the stack conveying direction.

Stacks being conveyed parallel to the flat expanse of the stacked printed products or the stack support surfaces (parallel conveyance) are conveyed along the collating route substantially one behind the other and the distance between stacks along the collating route is essentially determined by the largest product formats to be processed. In the case of stack conveyance not parallel to but substantially transverse to the flat expanse of the printed products or stack support surfaces (transverse conveyance), the stacks are arranged along the collating route substantially lying one behind the other, so that the distance from stack to stack in essence is determined by the greatest stack height or stack thickness to be anticipated. Because the stacks usually have a relatively small height or thickness in comparison with their width and length (flat expanse of the stacked products), this means that for an equivalent conveying capacity, parallel conveyance calls for a much higher speed than transverse conveyance.

The length of a collating route in each case is determined by the number of feed stations to be provided and by how much space each feed station requires along the collating route. With parallel conveyance, it is possible with relatively simple layouts to arrange the feed stations in such a manner, that the distance between two neighbouring feed stations is not much larger than the actual stack expanse in conveying direction. Such, in each conveying cycle a product can be added to the stack. If this were possible also for transverse stack conveyance, collating routes with transverse conveyance could be significantly shorter than collating routes with parallel conveyance. According to the prior art, however, this is not possible. Therefore, very compact collating layouts comprise combinations of parallel and transverse conveying systems. Examples of such combinations are drum-shaped arrangements, in which stacks in production are conveyed transverse around the circumference of the drum and simultaneously parallel in axial direction, which results in a spiral-shaped collating route. The same is achieved in linear layouts, in which the stacks in production are conveyed transverse together with V-shaped compartments and simultaneously are displaced parallel within the compartments, resulting in a route with a diagonal course.

One of the reasons, why feed stations to collating routes with transverse conveyance require a relatively large space, is due to the fact, that every printed product to be supplied has to be first inserted between two successive stacks or stack supports, before it can be positioned on one of the stacks. The smaller the distances between the stack supports are, the higher is the accuracy demanded of the insertion step. Usually the products are supplied from above held at upper edges in a hanging position. They are then inserted between the stack supports still hanging and are released, when the held upper edges are still positioned above the stack support. This means that during insertion, the leading edge is substantially unguided and that for a product with a length between leading and trailing edge being small relative to the height of the stack supports, the free fall after release is relatively long. This in turn means, that insertion is to be carried out relatively slowly and therefore, requires several conveying cycles and therefore, feed stations along the collating route need to have a corresponding length. It further signifies, that a system of this kind imposes tight limits on the format variations for printed products to be fed and that the absolute conveying speeds have an upper limit, this in particular, when the products to be fed are not very stable and get deformed by a low relative wind speed already.

A collating system with a multitude of V-shaped compartments, into which at every feed station a printed product is inserted from a hanging position and laid against the trailing wall of the compartment, is described e.g. in the publication CH-668245. The feed stations in this system are arranged one behind the other and with a distance between one another, which is almost twenty times greater than the extent of the compartments in the conveying direction (approx. twenty conveying cycles between two successive feed stations). In the publication EP-0857681, it is proposed to insert hanging products between L-shaped stack supports from one side and above and to release them, when their upper edge is laterally aligned to the stack support and is still positioned above it. In this manner it is possible, to arrange the feed stations along the collating route overlapping one another such reducing the distance between feed stations—depending on the arrangement—to a very few conveying cycles only. However, also in this case, the leading edges of the products are unguided during insertion so that the limitations regarding insertion speed and absolute conveying speed are the same as in the case of the insertion from above without a lateral component.

The object of the invention is to create a method and a device for gathering or collating flat articles, wherein method and device according to the invention shall make it possible not only to combine transverse conveyance along the gathering route with small distances between feed stations (in conveying cycles), but also to significantly expand the limits applicable up until now with respect to the processing of articles having different formats and with respect to conveying speed, even when processing not very stable articles. This means that the invention is to achieve gathering or collating in more compact layouts with higher piece per time unit capacities than is possible for gathering or collating according to prior art.

Method and device in accordance with the invention are based on the idea of inserting the flat articles to be added to the stacks between the stack supports while being held at their leading edges and of releasing them only when the inserted article is substantially aligned to the stack position and when only a very small, unguided movement is required for finally positioning the article on the stack or to laying it against the stack support. Immediately prior to insertion and during insertion, the articles are moved in a direction comprising a component parallel to the direction of stack conveyance. The articles are e.g. inserted into V-shaped compartments from above, the lower edge of each article to be inserted being held by a holding element and the holding element only being deactivated, when the held edge has essentially reached the floor of the compartment, by which floor the released article is supported for the onward conveyance. As will still have to be demonstrated, it is possible to feed the articles from the side or from below in substantially the same manner.

The held guidance of the leading edges during insertion between successive stacks enables a significantly higher insertion accuracy than held guidance of the trailing edges and therefore, renders insertion much less dependent on the stability of the articles and of the insertion speed. The higher insertion accuracy also makes it possible to have the stack support surfaces succeed one another more closely, which once again either enables the stack conveying speed to be reduced or, using the same stack conveying speed, the piece per time unit capacity to be increased. A further advantage resulting from holding the edges being the leading edges during insertion between stack supports and from the insertion accuracy associated with this, is the fact that it becomes possible to add to the stacks articles with greatly differing formats and thicknesses, without risking conflicts between them during insertion or during positioning on the stacks.

Regarding the device, the inventive idea or inserting of articles being held at there leading edge between stack supports respectively calls for a stack conveying means with stack supports being conveyed behind each other and feed means with holding elements being conveyed one behind the other and arranged in such a manner, that the conveying path of the holding elements traverses the conveying path of the stack supports. This means that the two conveying operations are to be matched to one another in such a way, that for the traversing, one holding element is moved between each two successive stack supports. Furthermore, control means are to be provided for deactivating the holding elements during the traversing, advantageously right at the end of traversing.

The conveying system with traversing conveying paths is implemented in an as such known manner, in that the stack supports are arranged on a first conveying organ (e.g., traction chain), the holding elements on a second one, the two conveying organs being independent of one another and arranged in planes parallel to one another. Stack supports and holding elements are arranged facing towards each other on the corresponding conveying organ, in such a manner, that at the crossing, they pass through one another in a combing manner. It is also possible to provide more than two conveying organs in such a manner, that the holding elements pass between two stack support parts at a distance from each other or two holding element parts are conveyed on either side of the stack supports.

The method according to the invention and exemplary embodiments of the device in accordance with the invention are described in detail in conjunction with the following Figures wherein:

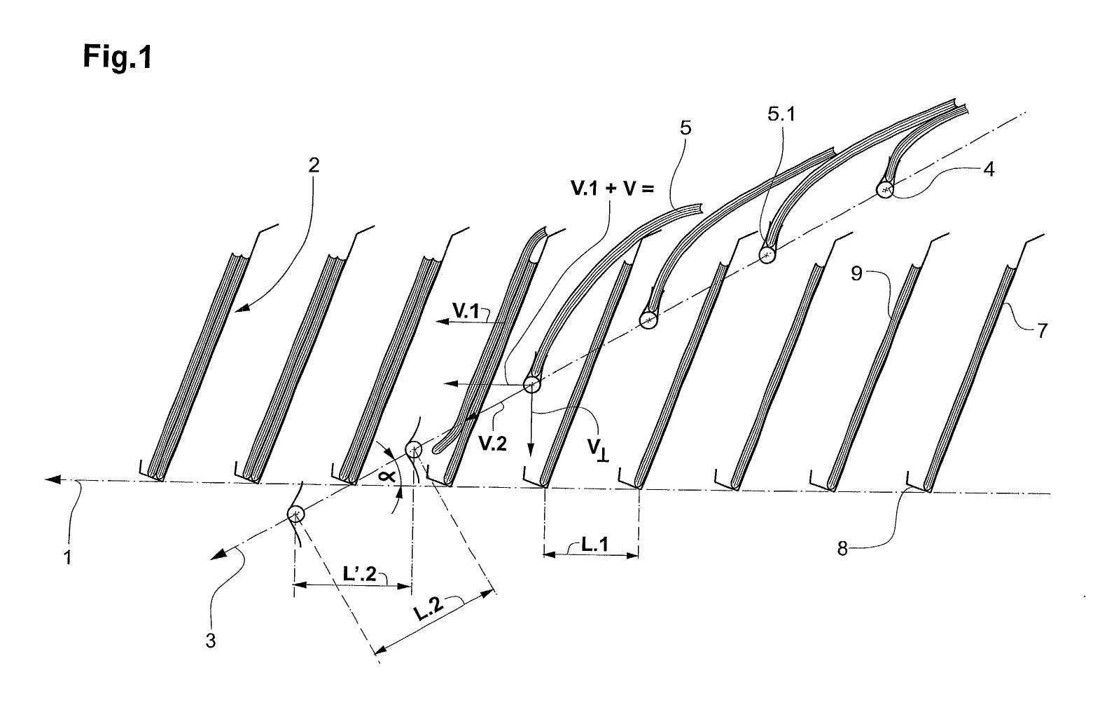

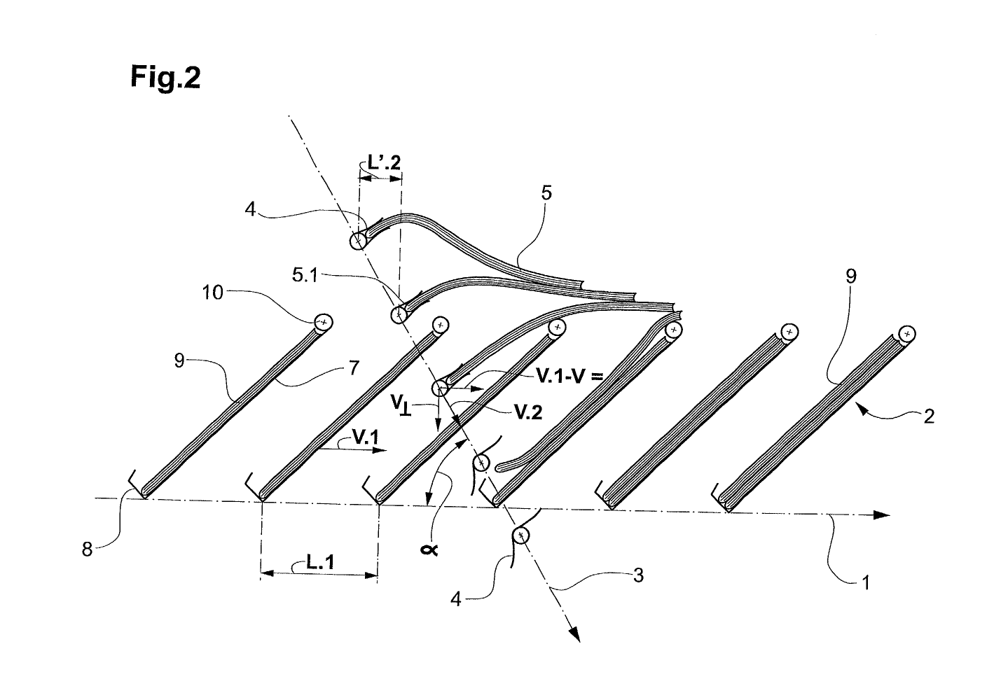

FIGS. 1 and 2 show the principle of the method according to the invention, illustrated by a process of inserting products between L-shaped stack supports and positioning them on the upstream stack support (FIG. 1) or on the downstream stack support (FIG. 2), viewed transverse to gathering route and feed direction;

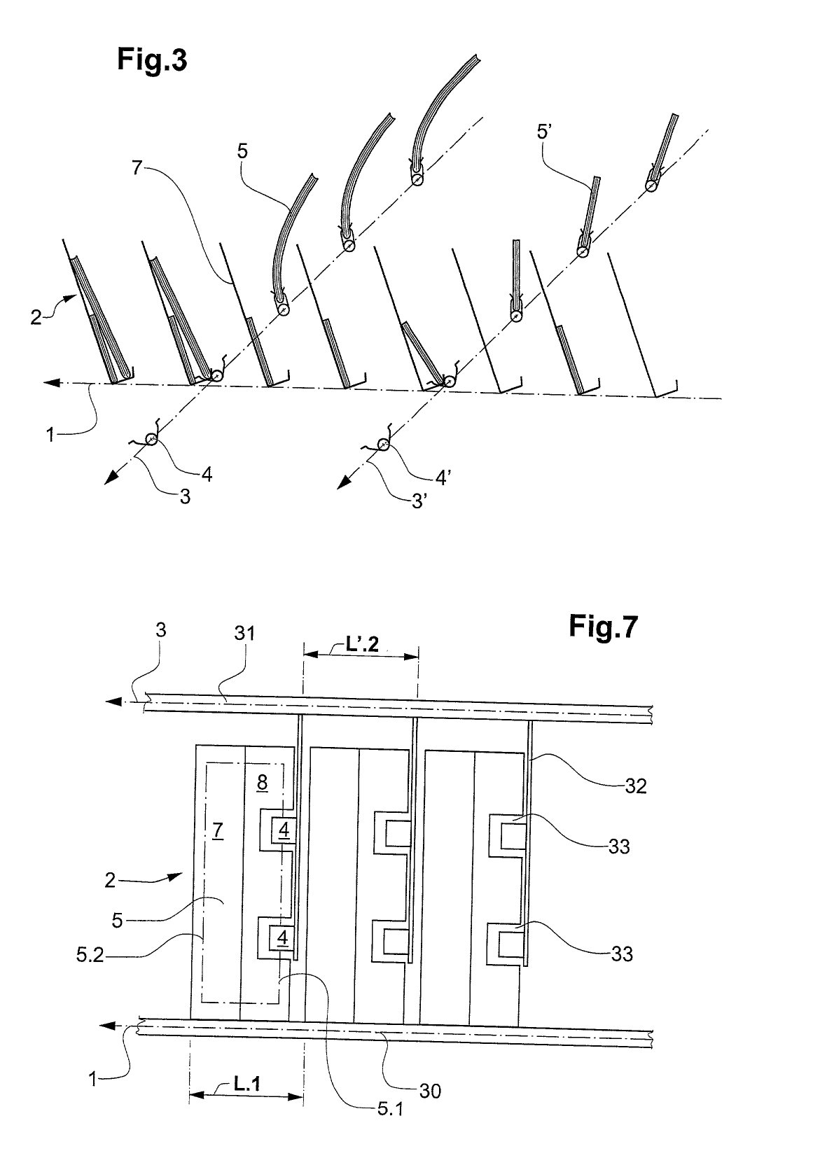

FIG. 3 shows a section of an exemplary gathering route with two consecutive feed stations;

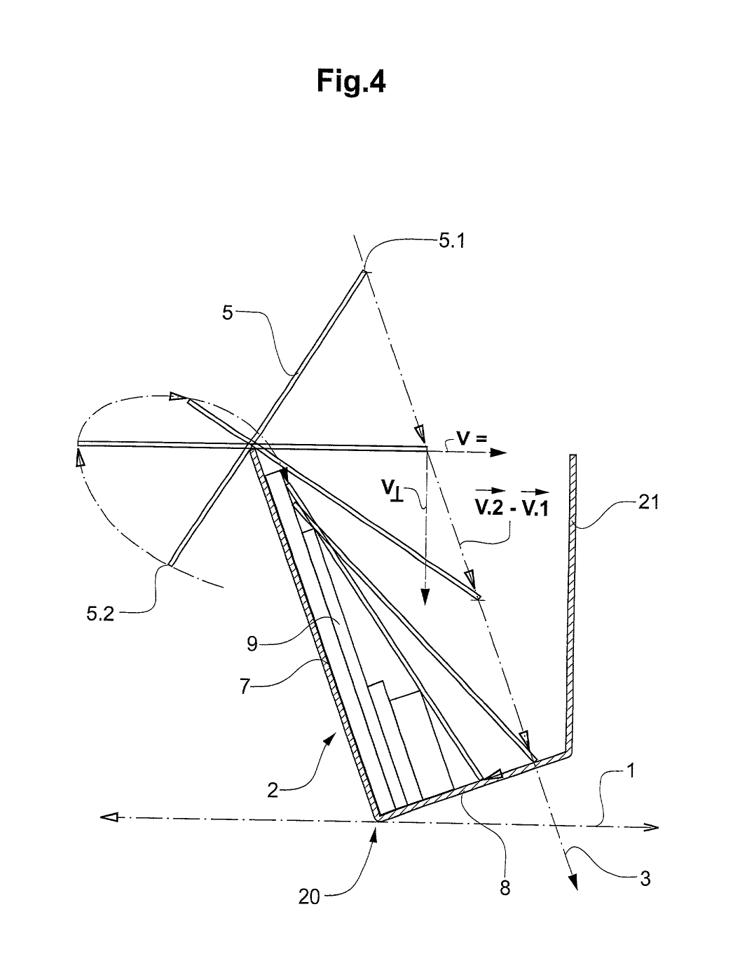

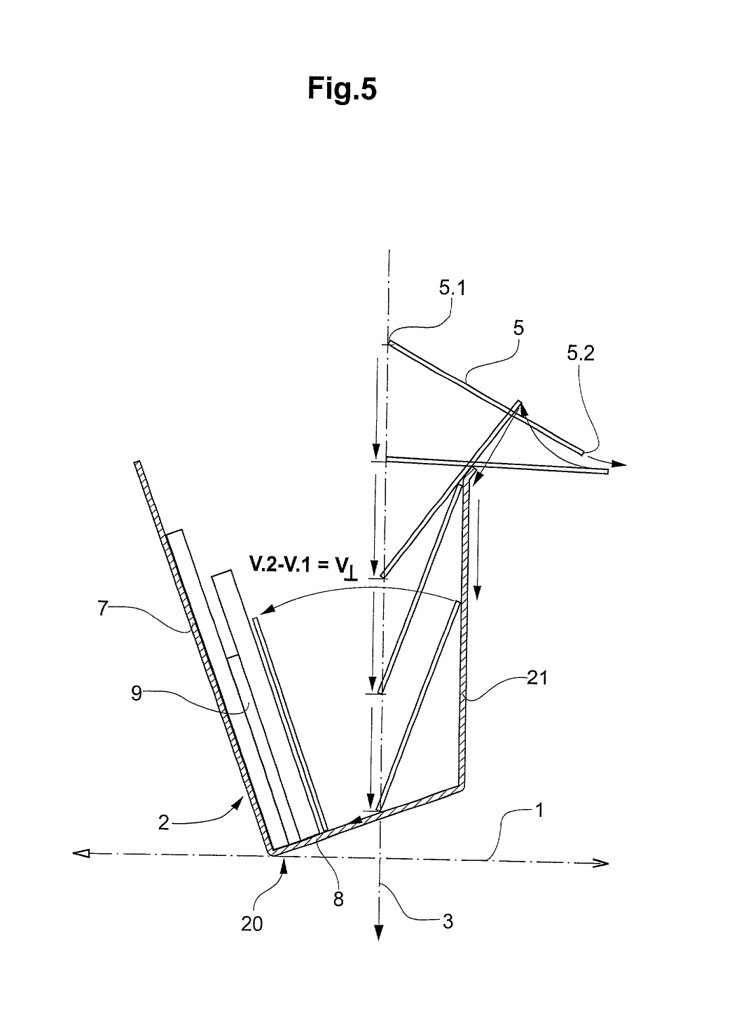

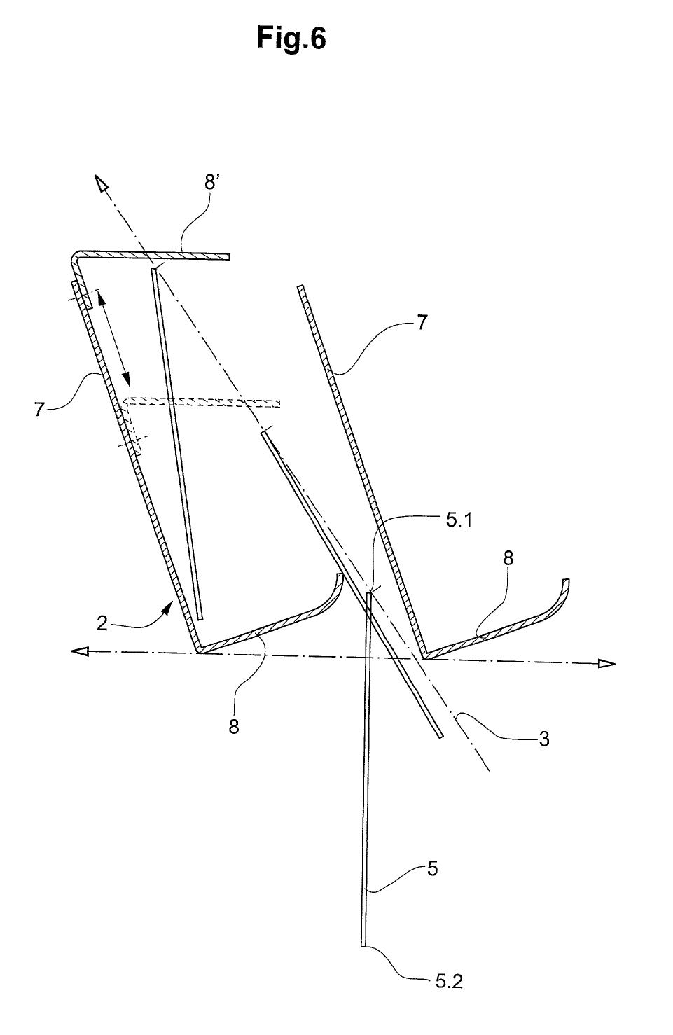

FIGS. 4 and 6 show insertion between stack supports and positioning on the stacks in detail for exemplary collating in V-shaped compartments (FIGS. 4 and 5) and on L-shaped stack supports (FIG. 6);

FIGS. 7 to 9 show three different, exemplary embodiments of the traversing conveying means with stack supports and holding elements (viewed parallel to the conveying planes).

FIGS. 1 and 2 serve for illustrating the method according to the invention and depict a part of two exemplary embodiments of the arrangement for gathering in accordance with the invention. Very schematically depicted are a gathering route 1 with stack supports 2 conveyed one after the other in the stack conveyance direction, extending transverse to the gathering route 1 and slanting in the stack conveyance direction and a supply route 3 with holding elements 4 in the form of grippers being closed for picking-up an article 5 and opened for releasing the gripped article 5 by corresponding control means (e.g. cams; not illustrated). The arrangement is viewed in both transverse to the conveying directions and parallel to the stack supports 2, so that of the latter and of the articles 5 to be gathered only the edges or narrow sides respectively are visible.

The gathering route 1 and the supply route 3 intersect in the zone of the feed station at an angle α smaller than 90°, i.e., the supply direction has a component parallel to the stack conveyance direction.

The L-shaped stack supports comprise a supporting surface 7 and a stop ledge 8 in both illustrated cases being located at the bottom of the supporting surfaces 7 and serving for supporting from below articles or stacks 9 lying against the supporting surfaces 7. The supporting surfaces 7 extend transverse to the conveying direction and form an advantageously acute angle with a vertical. The supporting surfaces 7 can also be arranged to be flatter or in the extreme case horizontal, therefore parallel to the stack conveyance direction.

The supplied articles 5 are represented as relatively flexible printed products, which are held at a fold edge (gripped edge 5.1). This, however, is not a condition for the invention, the articles 5 can also be rigid and/or can be held at any specific edge.

In accordance with FIG. 1, the stack supports are arranged in such a manner, that their upper edges are positioned further upstream than the lower edges. The supplied articles 5 are held by holding elements 4 in such a manner, that the gripped fold edges 5.1 are facing forward. This means that each one of the articles 5 is pulled over the upper edge of a supporting surface 7 when being inserted between the stack supports 2. These upper edges are e.g. slightly bent backwards or rounded in order to assure sliding down of the articles without problems. For releasing the articles 5, the holding elements 4 are opened immediately ahead of the height of the stop ledge 8. An object released in this way and not being driven after release, is caught up with, thanks to its inertia, by the following supporting surface 7 and, if so applicable, by the articles already stacked on it (stack 9). In this manner it is laid against the supporting surface or against the stack and is driven towards the stop ledge 8 by the force of gravity.

As shown by FIG. 1, the position of the holding element 4 is located approximately at the centre between the two stack supports during the four conveying cycles it needs for traversing the stack supports 2. This means that a stack 9 already present is not allowed to be thicker than half the distance between the stack supports 2. If this condition is fulfilled, then the leading, guided edge 5.1 cannot come into conflict with any already stacked article, even if these extend very little in the direction of the height of the stack supports 2.

The speed v.1 of the stack supports 2 being given, the holding elements as illustrated in FIG. 1 need to have a speed v.2, with a component in the direction of the gathering route 1 being greater than v.1 by a relative speed v= and a component v⊥ perpendicular to the gathering route 1 and corresponding to the desired insertion speed. The angle α and the distances L.2 (or their projection L′.2 onto the gathering route 1) between the holding elements 4 result from the ratio of v.1+v= and v⊥ and from the distances L.1 between the stack supports, wherein in the illustrated case v= is determined by the inclination of the supporting surfaces 7. The higher the insertion speed v⊥ is to be and the steeper the stack supports 2 are, the greater α becomes. In the case presented here, L′.2 and also L.2 are greater than L.1.

FIG. 2 illustrates a process of inserting articles 5 between consecutive stack supports 2 and positioning them on the supporting surface 7 of the downstream stack support 2. The supporting surfaces 7 have leading upper edges. For being supplied, the objects 5 are aligned in such a manner, that the gripped leading edges are facing upstream. The downstream facing, unguided parts of the supplied articles and the unguided edges 5.2 first meet with the upper edges of downstream stack supports 2 and during insertion are drawn over these. In order to prevent problems when the articles are drawn over them, the upper stack support edges may e.g. be equipped with corresponding, freely rotating rollers 10. The supplied articles 5 are drawn downwards over the supporting surfaces 7 or over articles (stack 9) already stacked on these, wherein the holding elements 4 at the beginning of the insertion are positioned closer to the supporting surface 2 downstream and at the end of the insertion closer to the supporting surface upstream. Because of this, the inserted article 5 is positioned on the supporting surface 7 or on articles already stacked on it (stack 9) and conveyed along with it, already before it is released from the holding element 4. After being released, it slides down onto the stop ledge 8 under the force of gravity. The supporting surfaces 7 are advantageously arranged less steep than in the case illustrated in FIG. 1. In such a way, the effect achieved by the inertia of the released articles in the embodiment according to FIG. 1 is taken over at least partially by the force of gravity.

The speed v.2 of the holding elements 4 for the embodiment illustrated in FIG. 2, comprises a component parallel to the gathering route 1, which is smaller than v.1 by a relative speed v=.L′.2 is therefore smaller than L.1.

As already mentioned further above, the stop ledges 8 on the stack supports 2 illustrated in the FIGS. 1 and 2 are located at the bottom and the articles 5 are inserted from above between the stack supports 2, wherein for the final positioning of the articles 5 on the supporting surfaces 7 or on articles already stacked on them, the force of gravity can be exploited. This, however, is not a condition for the method and the device according to the invention. FIGS. 1 and 2 can be quite readily understood as views from above instead of as side views, this in the meaning of a supply to a gathering route 1 from the side. In such a case, the stop ledge 8 as depicted solely serves to stop the released articles 5 and these are driven by the force of gravity against a not depicted edge of the supporting surface 7 inclined along the stack conveyance direction. An arrangement in accordance with FIG. 1, in which also the inertia of the released objects is exploited for their positioning, in such a case will be more advantageous than an embodiment according to FIG. 2, in which this inertia is not exploited.

FIG. 3 shows in the same way as FIGS. 1 and 2 a further embodiment of the method according to the invention. The articles 5 are supplied with the gripped edges directed forwards (as in FIG. 1) and are then laid against the downstream supporting surface 7. To do this, it may be advantageous to make use of holding elements 4 (or 4′), which are capable of being swivelled relative to the supply route 3 or 3′, so that the articles prior to being released can be swivelled against the leading supporting surface 7. This is applicable in particular for rigid articles 5′ being supplied to the first feed station as shown in FIG. 3 (feed route 3′, holding element 4′).

FIG. 3 also makes it clear, how close together the feed stations can be positioned along a gathering route 1 according to the invention. In the illustrated case, the distance between the feed stations amounts to only three conveying cycles.

FIGS. 4 to 6 depict supplied articles 5 during successive phases of their insertion between the stack supports 2. In FIGS. 4 and 5, the functions of the supporting surface 7, the stop ledge 8 and an adjacent stack support are taken over by the corresponding parts of a V-shaped compartment 20, into which a flat article 5 is being inserted from above. In FIG. 6, the stack support 2 is L-shaped and the article 5 is inserted from below. The illustrated insertions are viewed from a point conveyed along with the stack support 2 (direction of view transverse to the gathering route). Therefore, in order to see the absolute movements, stack conveyance (in all Figs. having a horizontal direction) is to be superimposed on the illustrated movements. The depicted movement of each holding element and gripped edge 5.1 along the supply route 3 has a relative speed v.2-v.1 (vector difference) with the components v=(relative speed) and v⊥ (insertion speed).

In FIGS. 4 to 6, the article to be inserted 5 is depicted as rigid. This makes it necessary that the holding elements (not shown) are designed for at least passive swivelling relative to the supply route 3 during the insertion. Bendable articles if so applicable do not require swivellable holding means. The insertion, however, takes place in an analogue manner wherein the articles are bent.

FIG. 4 illustrates insertion from above into a V-shaped compartment 20. Of this compartment, one side wall takes over the function of the supporting surface 7 and the floor assumes the function of the stop ledge 8. The second side wall 21 of this embodiment has no function. The gripped edge 5.1, which during supply is directed away from the supporting surface 7, is guided against the stop ledge 8 in a direction substantially parallel to the supporting surface 7 and shortly before the ledge, it is released from being held. During insertion, the article 5 or its edge 5.2 opposite the gripped edge 5.1 respectively is drawn over the top edge of the stack supporting surface 7 and then slides downwards along the stack supporting surface 7 or along a stack 9 lying on it, as is already illustrated in FIGS. 1 and 2. When the gripped edge 5.1 is released, it is driven against the stop ledge 8 by the force of gravity. If stack conveyance is directed from left to right (positioning on the upstream stack support), then the article 5 is driven against the supporting surface 7 by the force of gravity and by its inertia. If stack conveyance is directed from right to left, then the inertia of the article 5 acts in a direction away from the supporting surface 7. In such a case it might be necessary to provide further means (e.g., a slider acting from the opposite wall 21) for the final positioning of the article 5 on the stack 9 in addition to the force of gravity. The direction of stack conveyance along the gathering route 1, however, does not play an essential role for the insertion.

FIG. 5 illustrates in the same manner as FIG. 4 insertion into a V-shaped compartment 20, wherein during insertion the article 5 is drawn over the opposite wall 21 of the compartment 20. The movement of the gripped edge 5.1 is in this case perpendicular to the gathering route 1, the relative speed v=of the holding element relative to the stack support is therefore equal to zero (L′.1=L.1). From FIG. 5 it is clearly evident, that for the final positioning of the inserted article 5 at least the inertia (stack conveyance from left to right) has to be effective or else further means as already mentioned have to be made use of.

FIG. 6 shows in the same way as FIGS. 4 and 5 a further way for inserting articles 5 between successive stack supports 2. The articles 5 are supplied from below substantially suspended. They are guided over the outside edge of the stop ledge 8 and by the force of gravity they are finally positioned standing upright on the stop ledge 8 and leaning against the supporting surface 7. The stop ledge 8 therefore in this embodiment does not have an actual stop function, but only a stack supporting function. For the stop function a second stop ledge 8′ can be provided in the upper zone of the stack support 2.

It is obvious, that also in this case the direction of the stack conveyance along the gathering route 1 plays a very subordinate role.

A disadvantage of the insertion illustrated in FIG. 6 consists in the fact, that the gripped edge 5.1 (top edge) is to be positioned opposite the stop ledge 8. Therefore, the movement necessary for the final positioning of the article 5 (free fall) is longer for articles having a shorter distance between the edges 5.1 and 5.2 than for articles with a correspondingly longer such distance, if the release position of the gripped edge 5.1 is not changed. This disadvantage, however, can easily be remedied, in that the position of the holding element, in which it is deactivated and the position of the second stop ledge 8′ (dot-dash position of 8′) are adapted to said distance.

FIGS. 1 to 6 illustrate exemplary methods for inserting articles between stack supports conveyed along a gathering route, wherein from the illustrated methods further methods can be easily derived. Advantageous application of one or the other method is dependent on the manner, in which the articles to be supplied are advantageously taken over and on the orientation in which they need to be stacked.

In all FIGS. 1 to 6, both the gathering route 1 as well as the supply route 3 are depicted as straight-lines, which in the case of constant conveying speeds v.1 and v.2 results in a straight-line insertion with a constant speed. This is in no way a condition for the method in accordance with the invention. In particular, for the generating an insertion speed v⊥ diminishing towards the end of the insertion, the supply route 3 can be designed as correspondingly curving towards the direction of the gathering route 1.

FIGS. 7 to 9 illustrate three exemplary embodiments of the arrangement according to the invention, viewed in a direction in general vertically to the viewing direction of FIGS. 1. to 3, i.e. in the case of a supply from below or from above equivalent to a bird's eye view. Very schematically depicted are respectively a plurality of stack supports 2 (or 2.1 and 2.2) being conveyed along a gathering route 1 (or 1.1 and 1.2) and a plurality of holding elements 4 (or 4.1 and 4.2) being conveyed along a supply route 3 (or 3.1 and 3.2). The stack supports 2 and the holding elements 4 are each arranged on at least one separate conveying organ 30 (or 30.1 and 30.2) and 31 (or 31.1 and 31.2). The conveying organs, for example, are traction chains.

FIG. 7 illustrates stack supports 2 each with a supporting surface 7 and a stop ledge 8 as well as pairs of holding elements 4 arranged on bars 32. The stack supports 2 are arranged on a first lateral conveying organ 30. The bars 32 are arranged on a second conveying organ 31. The second conveying organ 31 is arranged laterally opposite to the first conveying organ 30. The stop ledges 8 have passages 33 for the holding elements 4. The conveying organs 30 and 31 are driven synchronously in such a manner, that the holding elements 4 while traversing the gathering route 1 pass in a combing manner between stack supports 2 and through passages 33, and therewith out of the traversing zone. Immediately prior to passing through the passages 33, the holding elements 4 are deactivated and an article 5 gripped at its edge 5.1 is leaned against the supporting surface 7 and conveyed onwards standing on the stop ledge 8.

For the layout in accordance with FIG. 7, the distances L.1 and L′.2 between stack supports 2 and holding elements 4 in the direction of the gathering route 1 are equal. This signifies, that the position of the holding elements relative to the stack supports 2 remains unchanged in the direction of the gathering route 1 during insertion, as has already been described in connection with the FIG. 5. The arrangement, however, can also be implemented with different distances L.1 and L′.2.

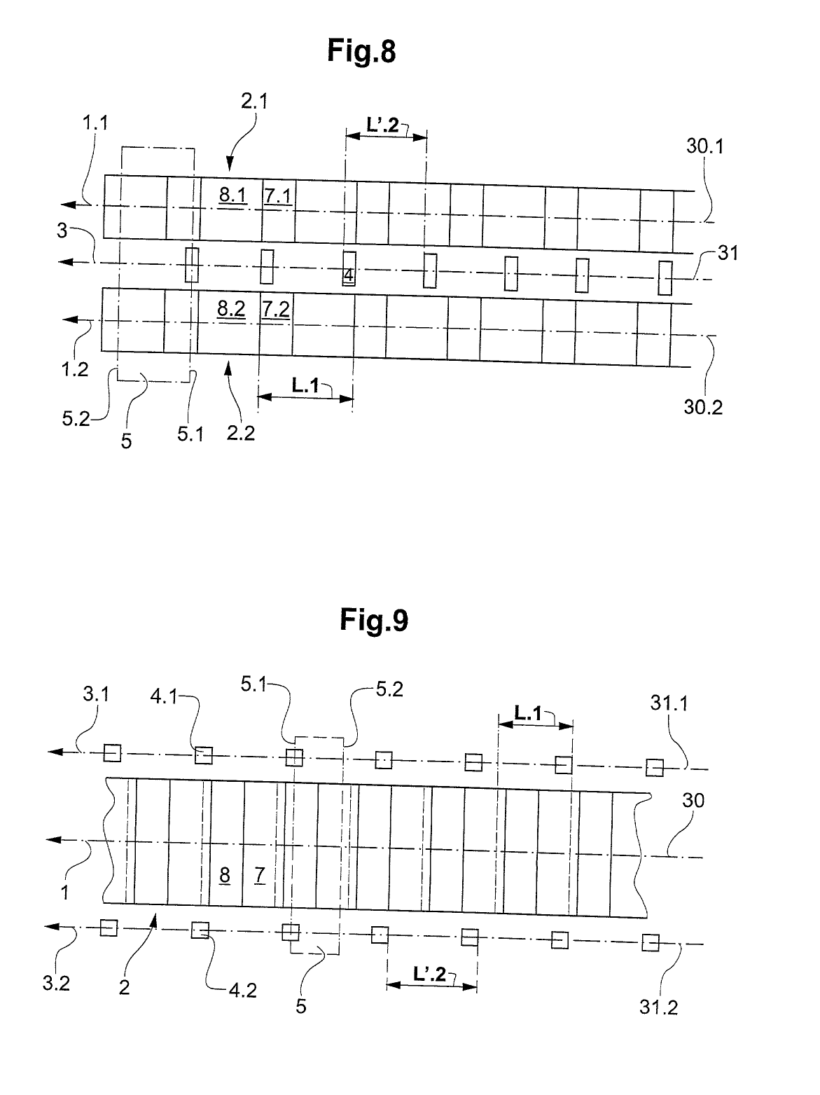

FIGS. 8 and 9 illustrate in the same manner as in FIG. 7 two further embodiments of the arrangement according to the invention. The stack supports and the holding elements in these cases are not designed to be passing through one another in the manner of a comb for the traversing of the two conveying tracks, but move separately from one another in parallel conveying planes, which are vertical to the paper plane.

FIG. 8 depicts an arrangement, in which the stack supports each comprise two stack support parts 2.1 and 2.2, which at a distance between one another are conveyed synchronously along the gathering route, each respectively by a first conveying organ 30.1 and 30.2. The holding elements 4, which are arranged on a second conveying organ 31, move between the stack support parts 2.1 and 2.2. The distances L.1 are greater than the distances L′.2, i.e., the holding elements 4 move between the stack supports against the stack support further upstream, as has also been described in connection with FIG. 2.

FIG. 9 illustrates an arrangement, in which the holding elements 4 each comprise two holding element parts 4.1 and 4.2, each of which respectively is conveyed by a second conveying organ 31.1 and 31.2 along the supply route at a distance from the other and synchronously with one another. The stack supports 2, which are arranged on a first conveying organ 30, move between the holding element parts 4.1 and 4.2. The stop ledges 8 of each stack support 2 reach underneath the supporting surfaces 7 of the preceding stack support further downstream, as is also depicted in FIG. 1. The distances L.1 and L′.2, i.e., the holding element parts 4.1 and 4.2, move between the stack supports 2 towards the stack support further downstream, as has also been described in connection with FIG. 4.

In all Figures, there are only parts of the conveying systems for conveying stack supports 2 and holding elements 4 illustrated. The complete systems comprise advantageously circulating conveying organs. i.e. the stack supports 2 are conveyed from the supply stations to a delivery station where the stacks 9 are delivered, and from there back to the beginning of the gathering route. The holding elements 4 are conveyed from the feed station to a take-over station where they are activated for taking over further articles 5. Then they are conveyed back to the feed-in station. The course of the circulation systems is to a great extent freely selectable and can be adapted to the most diverse conditions, which do not have to be directly associated with the gathering operation.

1. Method for gathering flat articles (5) in stacks (9) of one or more articles (5) each, the method comprising the step of conveying the stacks (9) being produced one after the other along a gathering route (1) in a stack conveyance direction and past at least one feed station, each stack lying against a supporting surface (7) of a stack support (2), the method further comprising the steps of supplying articles (5) along a supply route (3) in a feed direction to the feed station, inserting one of the flat articles (5) between each two successive stacks (9) or stack supports (2) respectively and positioning the inserted article on one of the two successive stacks (9) or supporting surfaces (7) of stack supports respectively, wherein the supply direction comprises a component parallel to the stack conveyance direction, and wherein the articles (5) are inserted between two successive stacks (9) or stack supports (2) while being gripped on their leading edges (5.1).

2. Method in accordance with claim 1, characterized in that the stack supports are aligned not parallel to the stack conveyance direction.

3. Method according to claim 1, characterized in that of the stack supports (2) each one comprises a stop ledge (8) at a bottom edge of the supporting surfaces (7), that the articles (5) are inserted between the stacks (9) or the stack supports(2) from above, the gripped edges (5.1) directed downwards and that the articles (5) are released from being held, when the gripped edge (5.1) is positioned immediately above the stop ledge (8).

4. Method in accordance with claim 3, characterized in that the articles (5) are conveyed towards the feed station with their gripped edges (5.1) directed forwards and are positioned on the upstream stack (9) or on the upstream supporting surface (7) respectively.

5. Method according to claim 3, characterized in that the articles (5) are conveyed towards the feed station with their gripped edges (5.1) directed backwards and are positioned on the downstream stack (9) or on the downstream supporting surface (7) respectively.

6. Method in accordance with claim 1, characterized in that, during insertion of the articles between the stacks (9) or stack supports (2) respectively, the gripped edges (5.1) are conveyed more rapidly or more slowly in the stack conveyance direction than the stack supports (2).

7. Method according to claim 6, characterized in that the supporting surfaces (7) are positioned inclined or slanting relative to the gathering route (1) and that during insertion of the articles between the stacks (9) or stack supports (2) respectively the gripped edges (5.1) are conveyed in parallel to this inclination.

8. Method in accordance with claim 1, characterized in that the articles (5) are conveyed towards the feed station in a suspended manner and are inserted between the stacks (9) or stack supports (2) respectively from below, their gripped edges (5.1) directed upwards.

9. Method according to claim 1, characterized in that the articles (5) are conveyed towards the feed station with their gripped edge (5.1) oriented towards one side and that the articles are inserted sideways between the stacks (9) or stack supports (2) respectively.

10. Arrangement for gathering flat articles (5), the arrangement comprising a plurality of stack supports (2) and a plurality of holding elements (4), the stack supports (2) comprising a supporting surface (7) each and being conveyed one behind the other in a stack conveyance direction along a gathering route (1) past at least one feed station, the holding elements (4) being equipped for held supply of one flat article (5) each to the feed station and being conveyed one after the other in a supply direction along a supply route (3) towards the gathering route (1) and in the feed station being deactivated for releasing the article (5), wherein the supply direction comprises a component parallel to the stack conveyance direction, wherein the supply route (3) traverses the gathering route (1) at the feed station, wherein conveyance of the stack supports (2) and of the holding elements (4) are matched to one another in such a manner, that at the feed station one holding element (4) is conveyed between every pair of successive stack supports (2), and wherein the device further comprises means for deactivating the holding elements (4) during their conveyance between the stack supports.

11. Arrangement in accordance with claim 10, characterized in that the supporting surfaces (7) are aligned not in parallel with the gathering route (1).

12. Arrangement according to claim 10, characterized in that the stack supports (2) are arranged on at least one first conveying organ (30) and the holding elements (4) on at least one second conveying organ (31), wherein the conveying organs (30, 31) are arranged in planes parallel to one another at least in the area of the feed station.

13. Arrangement in accordance with claim 10, characterized in that the supporting surfaces (7) comprise lower and upper edges aligned transverse to the gathering route (1) and lateral edges aligned inclined relative to the gathering route (1), as well as stop ledges (8) located on the lower edge.

14 Arrangement according to claim 13, characterized in that the supply route (3) traverses the gathering route (1) from above to below and that the means for deactivating the holding elements (4) is arranged in such a manner, that the holding elements (4) are deactivated, when positioned in a lower zone of the stack supports (2).

15. Arrangement in accordance with claim 13, characterized in that the supply route (3) traverses the gathering route (1) from below to above and that the means for deactivating the holding elements (4) are arranged in such a manner, that the holding elements (4) are deactivated, when positioned in an upper zone of the stack supports (2).

16. Arrangement according to claim 15, characterized in that a second stop ledge (8′) is provided in the upper zone of each supporting surface.

17. Arrangement in accordance with claim 13, characterized in that the supply route (3) traverses the gathering route (1) from a first side of the stack supports (2) to a second, opposite side and that the means for deactivating the holding elements (4) are arranged in such a manner, that the holding elements (4) are deactivated, when positioned in a zone of the second, opposite side of the stack supports (2).

18. Arrangement according to claim 12, characterized in that the stack supports (2) are arranged laterally on a first conveying organ (30), that the holding elements (4) are arranged laterally on a second conveying organ (31) and that the first and the second conveying organ (30 and 31) are arranged in such a manner, that the holding elements (4) and the stack supports (2) pass in combing manner through one another in the traversing area.

19. Arrangement in accordance with claim 18, characterized in that the stop ledges (8) of the stack supports (2) comprise passages (33) for the holding elements (4).

20. Arrangement according to claim 12, characterized in that each one of the stack supports (2) comprises two stack support parts (2.1, 2.2) arranged at a distanced from one another transverse to the gathering route (1), each one of the two stack support parts being arranged on one of two first conveying organs (30.1 and 30.2), and that the holding elements (4) and the second conveying organ (31) are arranged to pass in the traversing zone between the stack support parts (2.1, 2.2).

21. Arrangement in accordance with claim 12, characterized in that each one of the holding elements (4) comprises two holding element parts (4.1 and 4.2) distanced from each other transverse to the gathering route (1), each holding element part being arranged on one of two second conveying organs (31.1 and 31.2) and that the stack supports (2) and the first conveying organ (30) are arranged between the holding element parts (4.1 and 4.2).

22. Arrangement according to claim 10, characterized in that the stack supports (2) are V-shaped compartments (20) arranged transverse to the gathering route (1) and comprising side walls arranged one behind the other in the stack conveyance direction and a floor joining the side walls, wherein one of the side walls serves as supporting surface (7) and the floor as stop ledge (8), and wherein the other side wall (21) is capable of taking over the function of the next upstream or downstream stack support (2).
